(19) United States
(12) Patent Application Publication
(10) Pub. No.: US 2015/0267150 A1
(43) Pub. Date: Sep. 24, 2015

(54) LIQUID DETERGENT COMPOSITION

(71) Applicant: The Procter & Gamble Company, Cincinnati, OH (US)

(72) Inventors: Meng CHEN, Beijing (CN); Gang SI, Beijing (CN); Suzan Hanne Lieve BAERT, Strombeek-Bever (BE); Karl Ghislain BRAECKMAN, GERPINNES (BE); Katerina KARAGIANNI, Paris (FR); Wojciech BZDUCHA, Courbevoie (FR)

(21) Appl. No.: 14/635,132

(22) Filed: Mar. 2, 2015

(30) Foreign Application Priority Data
Mar. 19, 2014 (WO) CN02014/073707

(51) Int. Cl. C11D 3/37; C11D 3/00; C11D 1/94

(52) U.S. Cl. CPC C11D 3/3776; C11D 1/94; C11D 3/0094

(57) ABSTRACT

A hand dishwashing detergent composition comprising a surfactant system and a suds boosting polymer the polymer comprising:
a) from about 88 to about 92 mol % of a hydrophilic unit derived from N-vinylpyrrolidone; and
b) a cationic unit derived from a dimethyldiallylammonium salt
and wherein the polymer has a molar mass greater than about 250,000 g/mol.

### FIELD OF THE INVENTION

The present invention relates to a hand dishwashing detergent composition comprising a surfactant system and a suds boosting polymer. The composition provides improved foaming properties.

### BACKGROUND OF THE INVENTION

Hand dishwashing detergent compositions should have a good suds profile while providing good soil and grease cleaning and at the same time the composition should provide a pleasant washing experience, i.e, good feel on the user's hands during the wash. The composition should also be easy to rinse. In addition, the composition should provide good finish, to the washed items.

Users usually see foam as an indicator of the performance of the detergent composition. Moreover, the user of a hand dishwashing detergent composition also uses the sudsing profile and the appearance of the foam (density, whiteness) as an indicator that the wash solution still contains active detergent ingredients. The user usually doses the dishwashing detergent depending on the foam ability and renews the wash solution when the suds subsides or when the foam does not look thick enough. Thus, a dishwashing detergent composition that generates little or low density foam would tend to be replaced by the user more frequently than it is necessary. Hand dishwashing detergent compositions need to exhibit good foam height and density as well as good foam duration during the initial mixing of the detergent with water and during the entire manual dishwashing operation.

Traditionally, hand dishwashing has been done by immersing the items to be cleaned in a sink full of water. The detergent is diluted in the water. New trends, seem to be moving towards the use of detergent in neat form. The detergent is either applied directly onto the item or onto a cleaning implement, such as a sponge. The properties of the detergent can be different when using it in diluted or neat form. Ideally a detergent composition should be such that provides the best experience for both types of uses: diluted and neat form.

WO2009/037188 A1 relates to a high foaming composition comprising a surfactant and an agent enhancing foam properties. The agent is a random copolymer comprising cationic units. The copolymers explicitly disclosed in this patent application do not however meet all the consumer needs in terms of suds profile and finish on the washed items and/or the user's hands after a manual dishwashing operation.

Still there is a need to provide hand dishwashing compositions with improved foam properties and that at the same time provides good soil and grease removal. In addition, the hand dishwashing detergent composition should provide a pleasant experience for the user and it should not leave the cleaned items and the user's hand with a greasy feel.

### SUMMARY OF THE INVENTION

According to a first aspect of the invention, there is provided a hand dishwashing detergent composition. The composition is preferably in liquid form. The composition comprises a surfactant system and a suds boosting polymer. The polymer comprises:

a) from about 88 to about 92 mol %, preferably from about 89 to about 91 mol %, more preferably about 90 mol % of a hydrophilic unit derived from N-vinylpyrrolidone; and

b) a cationic unit derived from a dimethyldiallylammonium salt, preferably N,N-dimethyldiallylammonium chloride (DADMAC).

The polymer has a molar mass greater than about 250,000 g/mol.

The composition of the invention provides good cleaning and good suds profile. It presents benefits in terms of tough food cleaning (cooked-, baked- and burnt-on soils) and grease cleaning. In addition, the composition of the invention does not have the negatives that sometimes can be associated to compositions comprising suds boosting polymers: greasy and slippery feel during wash, in particular when the compositions are used in neat form. The greasy feel can also be left on the washed items, this can be more noticeable on plastic items. The composition of the invention does not provide greasy or slippery feel during wash when used either under neat or diluted form. The composition of the invention presents a very good rinsing profile, it is easy to get rid of the foam after washing the items. It leaves the washed items with a good finish, by good finish is herein meant that the washed items do not feel greasy or slippery either during or after rinse and the washed items feel agreeable to the touch.

Other advantages associated with the composition of the invention include that the composition presents good stability due to the compatibility of the polymer with the remaining ingredients of the composition. The composition can also be aesthetically pleasant because the presence of the polymer does not alter the appearance of the composition, i.e. transparent, translucent, etc. The composition of the invention can also contribute to a faster drying of the washed items. The composition can also contribute to a reduction of water marks.

The hydrophilic unit derived from N-vinylpyrrolidone is sometimes herein referred as “the hydrophilic unit”. The cationic unit derived from a dimethyldiallylammonium salt is sometimes herein referred as “cationic unit”. Preferred counter ions for the dimethyldiallylammonium include fluoride, chloride, bromide, iodine, bisulphate, alkyl sulphate (preferably methylsulfate or ethylsulfate), dihydrogen phosphate, hydrogen alkyl phosphate, dialkyl phosphate, etc. The most preferred counter ion is chloride.

The polymer of the composition of the invention is substantially free of units other than the hydrophilic unit and the cationic unit. By “substantially free” is herein meant that the polymer comprises less than 5%, preferably less than 2%, more preferably less than 1% and specially less than 0.5% moles of units other than the hydrophilic unit and the cationic unit.

Preferably the polymer comprises from about 8 to about 12 mol %, more preferably from about 9 to about 11 mol % and especially about 10 mol % of the cationic unit.

Preferred for use herein are random polymers, more preferably linear random polymers. The randomly distributed cationic units can bind anionic surfactants along the polymer backbone, and the resulting complex structure can emulsify greasy soils and stabilize air in foam more effectively than block polymers which only have a partial chain length to interact with greasy soils.

The molar mass of the polymer is greater than about 250,000 g/mol, preferably from about 250,000 to about 3,000,000 g/mol, more preferably from about 275,000 to about 1,000,000 g/mol and especially from about 300,000 to about 500,000 g/mol.

Preferred molar ratio of the hydrophilic unit to the cationic unit is about 90:10. Compositions comprising polymers having these unit molar ratios and molar masses are very good in terms of lack of slippery feel during the wash.

The polymer of the composition of the present invention is very effective, thus the level of polymer required to get the benefit is low. Preferably, the level of polymer is from about 0.05% to about 5%, more preferably from about 0.08% to about 2% and especially from about 0.1% to about 2% by weight of the composition.

In terms of surfactant system to polymer ratio, it is has been found that the best weight ratio is from about 10:1 to about 300:1, more preferably from about 50:1 to about 200:1 and especially from about 75:1 to about 150:1.

The surfactant system of the detergent of the invention can comprise any cleaning surfactant. Very good grease cleaning and at the same time very good suds profile have been found when the surfactant system comprises: i) an anionic surfactant; and ii) an amphoteric and/or zwitterionic surfactant. Preferably the weight ratio of anionic surfactant to amphoteric and/or zwitterionic surfactant is less than 9:1, more preferably less than 5:1, more preferably less than 4:1 and especially from about 3:1 to about 3.5:1.

Preferably the surfactant system comprises an anionic surfactant, the anionic surfactant can be any anionic cleaning surfactant, especially preferred are alkoxylated anionic surfactants, more preferably an alkyl alkoxy sulphate. Preferably the alkoxylated anionic surfactant has an average alkoxylation degree of from about 0.2 to about 3, preferably of from from about 0.2 to 1. Also preferred are branched anionic surfactants having a weight average level of branching of from about 5% to about 40%.

Extremely useful surfactant systems for use herein include those comprising: anionic surfactants, in combination with amine oxide and/or betaine surfactants.

Another preferred surfactant system for use herein is an anionic and amphoteric/zwitterionic system in which the amphoteric to zwitterionic weight ratio is preferably from about 2:1 to about 1:2. In particular a system in which the amphoteric surfactant is an amine oxide surfactant and the zwitteronic surfactant is a betaine and the weight ratio of the amine oxide to the betaine is about 1:1.

Also preferred for use herein are surfactant systems comprising non-ionic surfactants. Especially preferred surfactant systems for the composition of the invention comprise an anionic surfactant preferably selected from the group consisting of alkyl sulphate, alkyl alkoxy sulphate and mixtures thereof, more preferably an alkoxylated sulfate and an amphoteric surfactant, preferably an amino oxide surfactant and a non-ionic surfactant. In summary, the most preferred surfactant system for use herein comprises an alkoxylated sulfate surfactant, amine oxide and non-ionic surfactant.

According to the second aspect of the invention, there is provided a method of manual dishwashing comprising the step of: delivering the detergent composition of the invention to a volume of water and immersing soiled dishware in the water. When the composition of the invention is used according to this method an excellent suds profile, with a long lasting effect is achieved.

For the purpose of this invention “dishware” herein includes cookware and tableware.

According to the last aspect of the invention, there is provided a method of manual dishwashing comprising the step of: delivering the detergent composition of the invention directly onto dishware or onto a cleaning implement and using the cleaning implement to clean the dishware. Preferably the cleaning implement is a sponge and more preferably the sponge is wet. When the composition of the invention is used according to this method no greasy or slippery feel is sensed by the hands of the user during the washing process. In some instances, suds boosting polymers can give raise to a greasy and slippery feel during wash but this is not the case when the composition of the invention is used. It is also noted that the composition of the invention is very easily rinsed. In some instances, it has been found that suds boosting polymers can slow down the speed of rinsing, negatively impacting the user experience; however, that does not seem to be the case when using the composition of the invention.

### DETAILED DESCRIPTION OF THE INVENTION

The present invention envisages a hand dishwashing detergent composition. Preferably in liquid form. The detergent composition comprises a suds boosting polymer and a surfactant system. It provides very good cleaning; especially grease cleaning even on plastic substrates that are the toughest substrates for grease removal. It is also good for tough food cleaning, including cook-, baked- and burnt-on cleaning. It provides a very good finish of the washed items. The washing process is very agreeable, not exposing the hands to greasy feel and the washed items are left pleasant to the touch, free of strikes and with a good shine.

“Polymer,” as used herein and as defined by F W Billmeyer, JR. in Textbook of Polymer Science, second edition, 1971, is a relatively large molecule made up of the reaction products of smaller chemical repeat units. Normally, polymers have 11 or more repeat units. Polymers may have structures that are linear, branched, star shaped, looped, hyperbranched, crosslinked, or a combination thereof; polymers may have a single type of repeat unit or they may have more than one type of repeat unit. Polymers may have the various types of repeat units arranged randomly, in sequence, in blocks, in other arrangements, or in any mixture or combination thereof. Chemicals that react with each other to form the repeat units of a polymer are known herein as “monomers” and a polymer is said herein to be made of “polymerized units” of the monomers that reacted to form the repeat units.

In the present patent application, the molar percent (mol %) of a monomer unit in a polymer (which is the amount of this monomer unit within the copolymer, expressed in mol %) can be calculated by dividing the molar amount of said monomer unit introduced in the reaction mixture during the polymerization reaction by the total molar amount of monomer units introduced in the reaction mixture during the polymerization reaction (full conversion).

In the present patent application, unless otherwise indicated, when reference is made to “molar mass”, it will relate to the absolute weight-average molar mass, expressed in g/mol. This can be determined by gel permeation chromatography (GPC), with Multi-Angle Laser Light Scattering (MALLS) detection and an aqueous eluent.

In particular, the molar mass of the copolymer of the invention may be determined by GPC, with a 0.1M NaNO₃ aqueous eluent containing 200 ppm of NaN₃ and 20 ppm (calculated as dry polymer) of a polyDADMAC polymer [available from Aldrich (product reference 409022): polydiallyldimethylammonium chloride solution in water at 20 wt %; medium molecular weight Mw=200-350 kg/mol], the measure being carried out on a sample containing about 0.5 weight % (calculated as dry polymer) of the copolymer in the above described aqueous eluent (mobile phase).

More especially, the chromatographic conditions and calculations may be the following: A sample is diluted in the mobile phase (i.e. the above described aqueous eluent containing 200 ppm of NaN₃ and 20 ppm (calculated as dry polymer) of a polyDADMAC polymer), homogenized at least overnight and filtered through 0.45 microns Millipore filter.

Then the sample may be observed by GPC under the following conditions:
Mobile phase (eluent): 0.1M NaNO₃ water solution containing 200 ppm of NaN₃ and 20 ppm of a poly(DADMAC) polymer [available from Aldrich (product reference 409022): polydiallyldimethylammonium chloride solution in water at 20 wt %; medium molecular weight Mw=200-350 kg/mol]
Flow rate: 1 ml/min
Column: Shodex OHpak SB 806M HQ (3 columns; 30 cm)
Detection: RI (concentration detector Agilent)+MALLS (Dawn Heleos)
Sample concentration: about 0.5 weight % (calculated as dry polymer) of the copolymer in the mobile phase (eluent)
Injection volume: 100 microliter.

Then the calculation of the molar masses relies on the increment of refractive index (“dn/dc”) of the polymer.

The “dn/dc” value of a specific homo-polymer is known to a person skilled in the art, and can be found for example in POLYMER HANDBOOK. For a copolymer “dn/dc” can be calculated relatively to the weight composition of the copolymer using data available for the adequate homopolymers.

For instance, according to the present invention, the following values for the increment of refractive index “dn/dc” were used for (VP/DADMAC) copolymers:
0.1350 mL/g for (VP/DADMAC) copolymers having 90 mol % of VP units and 10 mol % of DADMAC units.

For each specific copolymer of the invention, the molar mass may be calculated based on the second order adjustment of the log (M)=f (elution volume) curve.

The electrical behavior or nature (neutral, anionic or cationic) of units may depend on the pH of the environment of the copolymer, typically the pH of the composition or of a medium where the composition is used. By cationic it is meant that the unit is cationic whatever the pH, in a range of pH 3-13, preferably pH 1-14. Units comprising a quaternary ammonium group are considered as cationic.

The Detergent Composition

The detergent composition is a hand dishwashing detergent, preferably in liquid form. It typically contains from 30% to 95%, preferably from 40% to 90%, more preferably from 50% to 85% by weight of a liquid carrier in which the other essential and optional components are dissolved, dispersed or suspended. One preferred component of the liquid carrier is water.

Preferably the pH of the detergent is adjusted to between 3 and 14, more preferably between 4 and 13, more preferably between 6 and 12 and most preferably between 8 and 10. The pH of the detergent can be adjusted using pH modifying ingredients known in the art.

Suds Boosting Polymer

A “suds boosting polymer” is a polymer that boosts the suds when added onto a detergent composition. The suds boosting polymer of the composition of the invention comprises two units: a hydrophilic unit derived from N-vinylpyrrolidone and a cationic unit derived from a dimethyldiallylammonium salt, preferably N,N-dimethyldiallylammonium chloride. The suds boosting polymer of the composition of the invention can help to reduce the level of surfactant system without impacting or even improving the suds profile of the detergent. Preferably, the level of polymer is from about 0.05% to about 5%, more preferably from about 0.08% to about 2% and especially from about 0.1% to about 2% by weight of the composition. Preferably, the surfactant system polymer weight ratio to be found the best (in terms of cleaning, finish and suds profile) is from about 10:1 to about 300:1, more preferably from about 50:1 to about 200:1 and even more preferably from about 75:1 to about 150:1 and especially about 100:1.

The polymers of the composition of the invention can be random, or block, better suds boosting properties have been found when the polymer is a random polymer, more preferably a linear random polymer.

Preferably, the molar mass of the polymer is from about 250,000 to about 3,000,000 g/mol, more preferably from about 275,000 to about 1,000,000 g/mol and especially from about 300,000 to about 500,000 g/mol. Polymers of this molar mass have been found to provide very good suds profile in the detergent composition.

The hydrophilic unit constitutes from about 88 to about 92 mol %, preferably from about 89 to about 91 mol %, more preferably about 90 mol %. Preferably the polymer comprises from about 8 to about 12 mol %, more preferably from about 9 to about 11 mol % and especially about 10 mol % of the cationic unit. Especially preferred polymers for the composition of the invention have a molar ratio of the hydrophilic unit to the cationic unit of about 90:10.

The polymer of the composition of the invention can be provided in any practical form, for example in the dry solid form or in the vectorized form, for example in the form of a solution or of an emulsion or of a suspension, in particular in the form of an aqueous solution. The vectorized form, for example an aqueous solution, can in particular comprise from 5 to 70% by weight of the polymer, for example from 10 to 60% by weight, for example from 20 to 50% by weight. The aqueous solution can in particular be a solution obtained by an aqueous-phase preparation process, in particular a radical polymerization process.

Process for the Preparation of the Polymer

The polymer of the invention can be prepared by any appropriate process. The process will generally comprise a stage of radical polymerization, where monomers and a source of free radicals are brought together.

According to one embodiment, a mixture of a dimethyldiallylammonium salt, preferably N,N-dimethyldiallylammonium chloride (DADMAC) and of N-vinylpyrrolidone (VP) is polymerized in the presence of a source of free radicals, in order to obtain a polymer comprising units deriving from VP and units deriving from DADMAC.

According to a preferred embodiment, the process comprises a stage of polymerization by bringing together:
N,N-dimethyldiallylammonium chloride (DADMAC)
N-vinylpyrrolidone (VP), and
a source of free radicals.

The radical polymerization processes are known to a person skilled in the art. In particular, the source of free radicals, the amount of free radicals, the steps for introducing the various compounds (monomers, source of free radicals, and the like), the polymerization temperature and other operating parameters or conditions (like type of solvent, co-solvent, addition of non-solvent, addition of the polymer chain transfer agent or polymer chain terminating agent) can be varied in a known and appropriate way. A few details or instructions are given below.

The processes can be processes of batch type, of semibatch type or even of continuous type. A process of semibatch type typically comprises a step of gradual introduction of at least one monomer, preferably of all the monomers, into a reactor, without continuous departure of the reaction product, the reaction product, comprising the polymer, being recovered all at once at the end of the reaction.

It is noted that the polymerization can advantageously be carried out in aqueous solution.

Any source of free radicals can be used. It is possible in particular to generate free radicals spontaneously, for example by increasing the temperature, with appropriate monomers, such as styrene. It is possible to generate free radicals by irradiation, in particular by UV irradiation, preferably in the presence of appropriate UV-sensitive initiators. It is possible to use initiators or initiator systems of radical or redox type. The source of free radicals may or may not be water-soluble. It may be preferable to use water-soluble initiators or at least partially water-soluble initiators.

Generally, the greater the amount of free radicals, the more easily the polymerization is initiated (it is promoted) but the lower the molar masses of the polymers obtained.

Use may in particular be made of the following initiators:
peroxides, such as: hydrogen peroxides, tert-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, potassium persulfate or ammonium persulfate,
azo compounds, such as: 2,2′-azobisisobutyronitrile, 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis {2-methyl-N-[1,1-bis(hydroxymethyl)-2-hydroxyethyl]propionamide}, 2,2′-azobis[2-methyl-N-(hydroxyethyl)propionamide], 2,2′-azobis(N,N′-dimethyleneisobutyramidine)dihydrochloride, 2,2′-azobis(2-amidinopropane) dihydrochloride, 2,2′-azobis(N,N′-dimethyleneisobutyramide), 2,2′-azobis {2-methyl-N-[1,1-bis(hydroxymethyl)-2-hydroxyethyl]-propionamide}, 2,2′-azobis{2-methyl-N-[1,1-bis(hydroxymethyl)ethyl]propionamide}, 2,2′-azobis{2-methyl-N-(2-hydroxyethyl)propionamide} or 2,2′-azobis(isobutyramide)dihydrate,
redox systems comprising combinations, such as:
mixtures of hydrogen peroxide, alkyl peroxide, peresters, percarbonates and the like and of any iron salt, titanous salt, zinc formaldehydesulfoxylate or sodium formaldehydesulfoxylate, and reducing sugars,
alkali metal or ammonium persulfates, perborates or perchlorates, in combination with an alkali metal bisulfite, such as sodium metabisulfite, and reducing sugars, and
alkali metal persulfates in combination with an arylphosphinic acid, such as benzenephosphonic acid and others of a like nature, and reducing sugars.

The polymerization temperature can in particular be between 25° C. and 95° C. The temperature can depend on the source of free radicals. If it is not a source of UV initiator type, it will be preferred to operate between 50° C. and 95° C., more preferably between 60° C. and 80° C. Generally, the higher the temperature, the more easily the polymerization is initiated (it is promoted) but the lower the molar masses of the polymers obtained.

Surfactant System

The liquid detergent can comprise from about 1% to about 50%, preferably from about 5% to about 40% more preferably from about 8% to about 35% by weight thereof of a surfactant system. The surfactant system preferably comprises an anionic surfactant, more preferably an alkoxylated sulfate anionic surfactant. The system can optionally comprise an amphoteric, zwitterionic, non-ionic surfactant and mixtures thereof.

Preferably, the surfactant system comprises alkyl sulfates and/or alkyl ethoxy sulfates; more preferably a combination of alkyl sulfates and/or alkyl ethoxy sulfates with a combined average ethoxylation degree of less than 5, preferably less than 3, more preferably less than 2 and more than 0.5 and an average level of branching of from about 5% to about 40%.

Preferably, the composition of the present invention will further comprise amphoteric and/or zwitterionic surfactant, more preferably an amine oxide and/or betaine surfactant.

The most preferred surfactant system for the detergent composition of the present invention will therefore comprise: (i) 1% to 40%, preferably 6% to 32%, more preferably 8% to 25% weight of the total composition of an anionic surfactant, preferably an alkoxylated sulfate surfactant (2) combined with 0.01% to 20% wt, preferably from 0.2% to 15% wt, more preferably from 0.5% to 10% by weight of the composition of amphoteric and/or zwitterionic and/or nonionic surfactant, more preferably an amphoteric and even more preferred an amine oxide surfactant and a non-ionic surfactant. It has been found that such surfactant system in combination with the suds boosting polymer will provide the excellent cleaning required from a hand dishwashing detergent while having very good suds profile and provides a good finish of the washed items.

Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C8-C22 alkyl, or acyl group. Such surfactants are employed in the form of water-soluble salts and the salt-forming cation usually is selected from sodium, potassium, ammonium, magnesium and mono-, di- or tri-C2-C3 alkanolammonium, with the sodium, cation being the usual one chosen.

The anionic surfactant can be a single surfactant but usually it is a mixture of anionic surfactants. Preferably the anionic surfactant comprises a sulphate surfactant, more preferably a sulphate surfactant selected from the group consisting of alkyl sulphate, alkyl alkoxy sulphate and mixtures thereof. Preferred alkyl alkoxy sulphates for use herein are alkyl ethoxy sulphates.

Preferably the anionic surfactant is alkoxylated, more preferably, an alkoxylated branched anionic surfactant having an alkoxylation degree of from about 0.2 to about 4, even more preferably from about 0.3 to about 3, even more preferably from about 0.4 to about 1.5 and especially from about 0.4 to about 1. Preferably, the alkoxy group is ethoxy. When the branched anionic surfactant is a mixture of surfactants, the alkoxylation degree is the weight average alkoxylation degree of all the components of the mixture (weight average alkoxylation degree). In the weight average alkoxylation degree calculation the weight of anionic surfactant components not having alkoxylated groups should also be included.

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each anionic surfactant of the mixture and alkoxylation degree is the number of alkoxy groups in each anionic surfactant.

Preferably the anionic surfactant to be used in the detergent of the present invention is a branched anionic surfactant having a level of branching of from about 5% to about 40%, preferably from about 10 to about 35% and more preferably from about 20% to about 30%. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the anionic surfactant used in the detergent of the invention. Most preferably the branched anionic surfactant is selected from alkyl sulphates, alkyl ethoxy sulphates, and mixtures thereof.

The branched anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

Preferably, the surfactant system comprises at least 50%, more preferably at least 60% and preferably at least 70% of branched anionic surfactant by weight of the surfactant system, more preferably the branched anionic surfactant comprises more than 50% by weight thereof of an alkyl ethoxylated sulphate having an ethoxylation degree of from about 0.2 to about 3 and preferably a level of branching of from about 5% to about 40%.

Sulphate Surfactants

Suitable sulphate surfactants for use herein include water-soluble salts of C8-C18 alkyl or hydroxyalkyl, sulphate and/or ether sulfate. Suitable counterions include alkali metal cation or ammonium or substituted ammonium, but preferably sodium.

The sulphate surfactants may be selected from C8-C18 primary, branched chain and random alkyl sulphates (AS); C8-C18 secondary (2,3) alkyl sulphates; C8-C18 alkyl alkoxy sulphates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulphates include, those based on Neodol alcohols ex the Shell company, Lial-Isalchem and Safol ex the Sasol company, natural alcohols ex The Procter & Gamble Chemicals company.

Preferably, the branched anionic surfactant comprises at least 50%, more preferably at least 60% and especially at least 70% of a sulphate surfactant by weight of the branched anionic surfactant. Especially preferred detergents from a cleaning view point art those in which the branched anionic surfactant comprises more than 50%, more preferably at least 60% and especially at least 70% by weight thereof of sulphate surfactant and the sulphate surfactant is selected from the group consisting of alkyl sulphate, alkyl ethoxy sulphates and mixtures thereof. Even more preferred are those in which the branched anionic surfactant has a degree of ethoxylation of from about 0.2 to about 3, more preferably from about 0.3 to about 2, even more preferably from about 0.4 to about 1.5, and especially from about 0.4 to about 1 and even more preferably when the anionic surfactant has a level of branching of from about 10% to about 35%, %, more preferably from about 20% to 30%.

Sulphonate Surfactants

Suitable sulphonate surfactants for use herein include water-soluble salts of C8-C18 alkyl or hydroxyalkyl sulphonates; C11-C18 alkyl benzene sulphonates (LAS), modified alkylbenzene sulphonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

Nonionic surfactant, when present, is comprised in a typical amount of from 0.1% to 30%, preferably 0.2% to 20%, most preferably 0.5% to 10% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

Amphoteric Surfactant

Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3)O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

Zwitterionic Surfactant

Other suitable surfactants include betaines, such as alkyl betaines, alkylamidobetaine, amidazoliniumbetaine, sulfobetaine (INCI Sultaines) as well as the Phosphobetaine and preferably meets formula I:

R¹—[CO—X(CH₂)ₙ]ₓ—N⁺(R²)(R₃)—(CH₂)ₘ—[CH(OH)—CH₂]_{y}—Y- (I)

wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, O or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃- (Id)

in which R′1 as the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropylbetain.

The detergent composition herein may comprise a number of optional ingredients such as builders, chelants, conditioning polymers, cleaning polymers, surface modifying polymers, soil flocculating polymers, structurants, emmolients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, organic and inorganic cations such as alkaline earth metals such as Ca/Mg-ions and diamines, antibacterial agents, preservatives and pH adjusters and buffering means.

Method of Washing

Other aspects of the invention are directed to methods of washing dishware with the composition of the present invention. Said methods comprise the step of applying the composition, preferably in liquid form, onto the dishware surface, either in diluted or neat form and rinsing or leaving the composition to dry on the surface without rinsing the surface.

By “in its neat form”, it is meant herein that said composition is applied directly onto the surface to be treated and/or onto a cleaning device or implement such as a dish cloth, a sponge or a dish brush without undergoing any dilution (immediately) prior to the application. The cleaning device or implement is preferably wet before or after the composition is delivered to it. By “diluted form”, it is meant herein that said composition is diluted by the user with an appropriate solvent, typically water. By “rinsing”, it is meant herein contacting the dishware cleaned using a process according to the present invention with substantial quantities of appropriate solvent, typically water, after the step of applying the liquid composition herein onto said dishware. By “substantial quantities”, it is meant usually about 1 to about 10 liters.

The composition herein can be applied in its diluted form. Soiled dishes are contacted with an effective amount, typically from about 0.5 ml to about 20 ml (per about 25 dishes being treated), preferably from about 3 ml to about 10 ml, of the detergent composition, preferably in liquid form, of the present invention diluted in water. The actual amount of detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. Generally, from about 0.01 ml to about 150 ml, preferably from about 3 ml to about 40 ml of a liquid detergent composition of the invention is combined with from about 2000 ml to about 20000 ml, more typically from about 5000 ml to about 15000 ml of water in a sink having a volumetric capacity in the range of from about 1000 ml to about 20000 ml, more typically from about 5000 ml to about 15000 ml. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the dish surface is preferably accompanied by a concurrent scrubbing of the dish surface.

Another method of the present invention will comprise immersing the soiled dishes into a water bath or held under running water without any liquid dishwashing detergent. A device for absorbing liquid dishwashing detergent, such as a sponge, is placed directly into a separate quantity of undiluted liquid dishwashing composition for a period of time typically ranging from about 1 to about 5 seconds. The absorbing device, and consequently the undiluted liquid dishwashing composition, is then contacted individually to the surface of each of the soiled dishes to remove said soiling. The absorbing device is typically contacted with each dish surface for a period of time range from about 1 to about 10 seconds, although the actual time of application will be dependent upon factors such as the degree of soiling of the dish. The contacting of the absorbing device to the dish surface is preferably accompanied by concurrent scrubbing.

Alternatively, the device may be immersed in a mixture of the hand dishwashing composition and water prior to being contacted with the dish surface, the concentrated solution is made by diluting the hand dishwashing composition with water in a small container that can accommodate the cleaning device at weight ratios ranging from about 95:5 to about 5:95, preferably about 80:20 to about 20:80 and more preferably about 70:30 to about 30:70, respectively, of hand dishwashing liquid:water respectively depending upon the user habits and the cleaning task.

### EXAMPLES

### Example 1

### Preparation of VP/DADMAC 90 mol %/10 mol % copolymers

The following copolymers of Vinylpyrrolidone (VP) with diallyldimethylammonium chloride (DADMAC) were synthesized in water solution in presence of 2,2′-azobis-(2-methylpropionamidine)dihydrochloride (V-50, used as a thermal radical initiator).

The syntheses were carried out at lab scale in a glass reactor equipped with mechanical stirring, an efficient heating/cooling and temperature control system, and a vapor reflux system.

The monomer mixture and V-50 water initiator solution 2 were loaded to the reactor separately in a semi-batch way during specified times and at specified temperatures (see table 1 below). Additionally at given times the V-50 water initiator solutions 1, 3, 4 and 5 were loaded to the reactor as shot additions. The nitrogen sparge to the reaction mixture was used during all the synthesis.

The general synthesis procedure is the following:
1. Set up the initiator and monomer feed vessels on the balances and prime the charge lines.
2. Load demineralized water to reactor.
3. Begin agitation at 150 RPM.
4. Begin a nitrogen sparge. Maintain the sparge throughout the reaction.
5. Heat the reactor to 75° C.
6. Load the initiator solution 1 charge to the reactor as a shot addition.
7. Begin a co-feed of the semi-batch initiator solution 2 with the semi-batch monomer solution.
   a. Feed appropriate quantities of the initiator solution 2 over appropriate time (see table 1 below).
   b. Starting at the same time, feed appropriate quantities of the monomers solution mixture over appropriate time (see table 1 below).
8. After the end of the initiator solution 2 feed, keep heating at 75° C. during 1 hour
9. Heat the reactor to 85° C. during 15 minutes
10. Load the initiator solution 3 charge to the reactor as a shot addition
11. Keep heating at 85° C. during 2 hour
12. Load the initiator solution 4 charge to the reactor as a shot addition
13. Keep heating at 85° C. during 2 hour
14. Load the initiator solution 5 charge to the reactor as a shot addition
15. Keep heating at 85° C. during 2 hour
16. Cool the product to <40° C. and discharge the product (in the form of a liquid solution in water)

According to this procedure several copolymers were synthesized, with the same monomer molar ratio (namely 90 mol % of VP and 10 mol % of DADMAC) but different copolymer average molar masses (Mw ranging from 66 to 328 kg/mol).

The particular charges of the reagents and reaction conditions (monomers mixture and initiator solution 2 semi-batch feed durations, reaction temperature during semi-batch reagents feeds) are given in the table 1 below.

TABLE 1
Reagents charges and reaction conditions for particular copolymers synthesis.

| | | | Initiator | | Monomers mixture load | | | |
|---|---|---|---|---|---|---|---|---|
| | Molar | | solution 1 | | | | DADMAC | |
| | ratio (VP/ | Water | load | | | | at 65%, | feed |
| Example | DADMAC) | load, | V-50, | Water, | Water, | VP | water | duration, |
| reference | % mol | grams | grams | grams | grams | grams | solution, | minutes |
| Copolymer 1 | 90/10 | 246.4 | 0 | 0 | 140.5 | 662.6 | 165.3 | 180 |
| Copolymer 2 | 90/10 | 403.3 | 0.18 | 1.0 | 315.3 | 315.3 | 78.7 | 180 |
| Copolymer 3 | 90/10 | 310.0 | 1.25 | 5.9 | 91.3 | 430.2 | 107.3 | 180 |
| Copolymer 4 | 90/10 | 440.0 | 1.25 | 5.9 | 73.0 | 344.2 | 85.9 | 180 |

| | | | | Reaction | | |
|---|---|---|---|---|---|---|
| | | | | T ° C. | Initiator | |
| | | | | during Monomers | solutions | |
| | Initiator solution 2 load | | | and | 3, 4 and 5 | |
| | | | feed | Initiator | loads | |
| Example | V-50, | water, | duration, | solution 2 | V-50, | water, |
| reference | grams | grams | minutes | feeds | grams | grams |
| Copolymer 1 | 13.5 | 63.4 | 240 | 75 | 1.92 | 9.1 |
| Copolymer 2 | 1.47 | 71.9 | 240 | 75 | 1.83 | 5.0 |
| Copolymer 3 | 11.2 | 53.0 | 240 | 75 | 1.25 | 5.9 |
| Copolymer 4 | 9.0 | 42.4 | 240 | 75 | 1.00 | 4.7 |

The molar masses of these copolymers were determined according to the protocol detailed in the specification, namely by GPC, with a 0.1M NaNO₃ aqueous eluent containing 200 ppm of NaN₃ and 20 ppm (calculated as dry polymer) of a polyDADMAC polymer [available from Aldrich (product reference 409022): polydiallyldimethylammonium chloride solution in water at 20 weight %; medium molecular weight Mw=200-350 kg/mol], the measure being carried out on a sample containing about 0.5 weight % (calculated as dry polymer) of the copolymer in the above described aqueous eluent.

More especially, the chromatographic conditions and calculations were the following: A sample is diluted in the mobile phase (=the above described aqueous eluent containing 200 ppm of NaN₃ and 20 ppm (calculated as dry polymer) of a polyDADMAC polymer), homogenized at least overnight and filtered through 0.45 microns Millipore filter. Then the sample is observed by GPC under the following conditions:
Mobile phase (eluent): 0.1M NaNO₃ water solution containing 200 ppm of NaN₃ and 20 ppm of a polyDADMAC polymer [available from Aldrich (product reference 409022): polydiallyldimethylammonium chloride solution in water at 20 weight %; medium molecular weight Mw=200-350 kg/mol],
Flow rate: 1 ml/min
Column: Shodex OHpak SB 806M HQ (3 columns; 30 cm)
Detection: RI (concentration detector Agilent)+MALLS (Dawn Heleos)
Sample concentration: about 0.5 weight % (calculated as dry polymer) of the copolymer in the mobile phase (eluent)
Injection volume: 100 microliter.

The following value for the increment of refractive index “dn/dc” was used for (VP/DADMAC) copolymers:
0.1350 mL/g for (VP/DADMAC) copolymers having 90 mol % of VP units and 10 mol % of DADMAC units.

For each specific copolymer, the molar mass has been calculated based on the second order adjustment of the log (M)=f (elution volume) curve.

The results were the following:

| Example reference | VP molar %/DADMAC molar % | Mw (kg/mol) |
|---|---|---|
| Copolymer 1 | 90/10 | 328 |
| Copolymer 2 | 90/10 | 221 |
| Copolymer 3 | 90/10 | 95 |
| Copolymer 4 | 90/10 | 66 |

### Example 2

### Evaluation of the Suds Performances in Hand Dish Detergent Compositions

The suds performance of hand dishwashing detergent compositions (Examples A-E) was assessed according to the method described herein below.

Example A, containing no polymer, was used as a reference.

Examples C-E, outside the scope of the invention, were used as comparative examples.

| | Product (wt %) | | | | |
|---|---|---|---|---|---|
| | A | | | | |
| | (Ref) | B | C | D | E |
| Alkyl C₁₀₋₁₄ Ethoxy Sulphate (AE0.6S) | 20.15 | 20.15 | 20.15 | 20.15 | 20.15 |
| C12-14 dimethyl amine oxide | 5.45 | 5.45 | 5.45 | 5.45 | 5.45 |
| Branched Nonionic: 3-propyl heptanol | 0.40 | 0.40 | 0.40 | 0.40 | 0.40 |
| EO8 | | | | | |
| PEI600-EO10-PO7 block polymer | 0.3 | 0.3 | 0.3 | 0.3 | 0.3 |
| Ethanol | 2.5 | 2.5 | 2.5 | 2.5 | 2.5 |
| Polypropylene glycol MW2000 | 0.4 | 0.4 | 0.4 | 0.4 | 0.4 |
| Sodium Chloride | 1.0 | 1.0 | 1.0 | 1.0 | 1.0 |
| Poly-(VP-co-DADMAC) polymer | | | | | |
| Copolymer 1 (VP/DADMAC 90:10, | — | 0.3 | — | — | — |
| MW 328 kg/mol) | | | | | |
| Copolymer 2 (VP/DADMAC 90:10, | — | — | 0.3 | — | — |
| Mw 221 kg/mol) | | | | | |
| Copolymer 3 (VP/DADMAC 90:10, | — | — | — | 0.3 | — |
| Mw 95 kg/mol) | | | | | |
| Copolymer 4 (VP/DADMAC 90:10, | — | — | — | — | 0.3 |
| Mw 66 kg/mol) | | | | | |
| Minors* and water | to balance up to 100% | | | | |
| Performance: | Reference | | Comparative | Comparative | Comparative |
| Suds mileage index | 100 | 117 | 116 | 116 | 111 |

*Minors include perfume, dyes, preservatives
VP: vinylpyrrolidone
DADMAC: N,N-dimethyldiallylammonium chloride

The composition comprising a suds boosting polymer according to the invention (B) presented a significantly better suds mileage than the reference, and presented equivalent or better suds mileage than compositions comprising a similar polymer outside the scope of the invention (C, D and E).

This method measures the suds profile of a product versus a reference. The suds profile of the detergent composition herein can be measured by employing a suds cylinder tester (SCT). The SCT has a set of 8 cylinders.

Each cylinder is typically 30 cm long and 9 cm in diameter and may be independently rotated at a rate of 20 revolutions per minute (rpm).

For executing the test, 8 cylinders are used when comparing 7 or less test products versus a reference.

When not all cylinders contain a test product, the empty cylinder(s) should always be filled with the same amount of water as the other cylinders to maintain the right balance.

Composition of the artificial soil (available from J&R coordinating (Cincinatti, Ohio, USA)

| Ingredient | Wt (%) |
|---|---|
| Oleic acid | 0.14 |
| Crisco oil | 12.73 |
| Crisco shortening | 27.75 |
| Lard | 7.64 |
| Refined Beef Tallow | 51.68 |
| Palmitic acid | 0.04 |
| Stearic acid | 0.02 |
| Total | 100 |

Test Procedure
1. A water solution of a detergent composition to be tested is prepared by dissolving 0.6 g+/−0.01 g detergent composition into 500 ml water having water hardness of 15 dH and temperature of 41° C.
2. The water solution in the cylinder has a height which is deemed to be a constant during the whole test.
3. A scale is stuck on the external wall of each cylinder with 0 starting from the top surface of the cylinder bottom.
4. The SCT rotates at 20 rpm for a time period as specified below, then stop rotation and read the suds height which is the number of the top layer of suds minus the water solution height.
5. The height of the top layer of suds should be the line which crosses the interface of air and dense suds and is vertical to the cylinder wall.
6. Scattered bubbles clinging to the interior surface of the cylinder wall shall not be counted in reading the suds height.
7. The SCT first rotates at 20 rpm for 2 minutes.
8. Stop rotation and add 1 ml of artificial soil to each cylinder.
9. Start the SCT to rotate at 20 rpm for 1 minute.
10. After 1 minute, stop rotation and read the suds height.
11. Repeat steps 9 and 10 until suds height in each cylinder reaches 0.5 cm.
12. Repeat steps 1 to 11 with the product order reversed in the cylinders to remove bias between replicates.

Sample Result (for Illustration Purposes)

| | Run 1 | | | | Run 2 | | | |
|---|---|---|---|---|---|---|---|---|
| Additions | 1 | 2 | 3 | 4 | 4 | 3 | 2 | 1 |
| 0 | 7.5 | 7.8 | 7.9 | 7.4 | 8.0 | 7.7 | 8.0 | 7.2 |
| 1 | 6.7 | 7.7 | 7.4 | 7.2 | 7.3 | 7.4 | 8.0 | 6.5 |
| 2 | 5.7 | 7.3 | 6.9 | 5.4 | 5.0 | 6.7 | 7.2 | 5.5 |
| 3 | 3.5 | 6.2 | 5.3 | 3.6 | 3.6 | 5.0 | 6.0 | 3.5 |
| 4 | 1.5 | 4.5 | 3.8 | 1.7 | 1.6 | 3.5 | 4.4 | 1.5 |
| 5 | 0.9 | 0.8 | 0.7 | 0.5 | 1.0 | 1.4 | 2.2 | 0.7 |
| 6 | 0.4 | 0.8 | 0.7 | | 0.5 | 0.6 | 0.7 | 0.3 |
| 7 | | 0.6 | 0.5 | | | 0.4 | 0.5 | |
| 8 | | 0.3 | | | | | | |
| Total suds | 26.2 | 36.0 | 33.2 | 25.8 | 27.0 | 32.7 | 37.0 | 25.2 |
| Mileage | 5.8 | 7.3 | 7 | 5 | 6.0 | 6.5 | 7.0 | 5.5 |
| % Suds | 100 | 137 | 127 | 98 | 107 | 130 | 147 | 100 |
| % Mileage | 100 | 126 | 121 | 86 | 109 | 118 | 127 | 100 |

### Example 3

### Evaluation of the Greasy Feel on Items and Hand During and after Manual Dishwashing

The greasy feel on items and on the user's hands during and after manual dishwashing of the reference and Examples 1-4 was assessed according to the method described herein below.

| | Product (wt %) | | | | |
|---|---|---|---|---|---|
| | REF. | 1 | 2 | 3 | 4 |
| Alkyl C₁₀₋₁₄ Ethoxy Sulphate | 20.15 | 20.15 | 20.15 | 20.15 | 20.15 |
| (AE0.6S) | | | | | |
| C12-14 dimethyl amine oxide | 5.45 | 5.45 | 5.45 | 5.45 | 5.45 |
| Branched Nonionic: 3-propyl heptanol | 0.40 | 0.40 | 0.40 | 0.40 | 0.40 |
| EO8 | | | | | |
| PEI600-EO10-PO7 block polymer | 0.3 | 0.3 | 0.3 | 0.3 | 0.3 |
| Ethanol | 2.5 | 2.5 | 2.5 | 2.5 | 2.5 |
| Polypropylene glycol MW2000 | 0.4 | 0.4 | 0.4 | 0.4 | 0.4 |
| Sodium Chloride | 1.0 | 1.0 | 1.0 | 1.0 | 1.0 |
| Poly-(VP-co-DADMAC) polymer | | | | | |
| Copolymer 1 (VP/DADMAC 90:10, | — | 0.3 | — | — | — |
| Mw 328 kg/mol) | | | | | |
| Copolymer 2 (VP/DADMAC 90:10, | — | — | 0.3 | — | — |
| Mw 221 kg/mol) | | | | | |
| Copolymer 3 (VP/DADMAC 90:10, | — | — | — | 0.3 | — |
| Mw 95 kg/mol) | | | | | |
| Copolymer 4 (VP/DADMAC 90:10, | — | — | — | — | 0 3 |
| Mw 66 kg/mol) | | | | | |
| Minors* and water | to balance up to 100% | | | | |
| Performance: | Reference | | Comparative | Comparative | Comparative |
| Greasy feel on items | Intermediate | No | Yes | Intermediate | Yes |
| Greasy feel on hands | Yes | No | Yes | Yes | Yes |

Compositions of Example 1 (according to the invention) gives better performance than the reference, both in terms of greasy feel on items and greasy feel on hands after wash. Compositions 2, 3 and 4 (outside the scope of the invention) presented on the contrary inacceptable greasy feel during and after wash, both on the washed items and on hands.

Greasy Feel Evaluation Test Method

The greasy feel on items and hands during and after wash is evaluated by three different panelists by placing 0.5 ml of the test product on a sponge to wash a plastic container (available from IKEA under reference PRUTA 1.5 L) which has been soiled with a table spoon of sunflower oil. The wash is done using soft water (2 dH).

### Example 4

### Examples of Formulations

Other examples of formulations with suds boosting polymer: 5 to 11

| | 5 | 6 | 7 | 8 | 9 | 10 | 11 |
|---|---|---|---|---|---|---|---|
| Alkyl C₁₀₋₁₄ Ethoxy | 26.9 | — | — | 25.7 | — | 11.1 | 21.0 |
| Sulphate (AE0.6S) | | | | | | | |
| Alkyl C₁₀₋₁₄ Ethoxy | — | 18.7 | 26.9 | — | 18.7 | — | — |
| Sulphate (AE2S) | | | | | | | |
| Sodium alkyl benzene | — | 8.0 | — | — | — | — | — |
| sulfonate | | | | | | | |
| Sodium paraffin | — | — | — | — | 8.0 | — | — |
| sulfonate | | | | | | | |
| C12-14 dimethyl | 6.1 | — | — | 4.1 | — | 3.7 | 10.0 |
| amine oxide | | | | | | | |
| Cocamido propyl | — | 4.5 | 6.8 | 3.2 | 6.0 | — | — |
| betaine | | | | | | | |
| C12-13 EO7 nonionic | — | — | — | — | — | 1.0 | 2.0 |
| Branched Nonionic: | 1.0 | 0.8 | — | — | — | — | 1.0 |
| 3-propyl heptanol | | | | | | | |
| EO8 | | | | | | | |
| PEI600-EO10-PO7 | — | — | 0.8 | — | — | 0.4 | 0.8 |
| block polymer | | | | | | | |
| Ethanol | 4.0 | 5.0 | 3.0 | 3.0 | 2.0 | — | 3.0 |
| Polypropylene glycol | 1.1 | 0.8 | 1.1 | 1.1 | 1.1 | 0.5 | 1.1 |
| MW2000 | | | | | | | |
| Sodium Chloride | 1.3 | 0.8 | 1.3 | 0.5 | 0.8 | 1.3 | 1.3 |
| Copolymer 1 | 0.5 | 0.4 | 0.3 | 0.3 | 0.3 | 0.2 | 0.5 |
| (VP/DADMAC 90:10, | | | | | | | |
| Mw 328 kg/mol) | | | | | | | |

| | |
|---|---|
| Minors* and water | to balance up to 100% |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A hand dishwashing detergent composition comprising a surfactant system and a suds boosting polymer the polymer comprising:
a) from about 88 to about 92 mol % of a hydrophilic unit derived from N-vinylpyrrolidone; and
b) a cationic unit derived from a dimethyldiallylammonium salt
and wherein the polymer has a molar mass greater than about 250,000 g/mol.

2. A composition according to claim 1 wherein polymer comprises from about 8 to about 12 mol % of the cationic unit.

3. A composition according to claim 1 wherein the polymer is a random polymer,

4. A composition according to claim 1 wherein the dimethyldiallylammonium salt is N,N-dimethyldiallylammonium chloride.

5. A composition according to claim 1 wherein the molar mass of the polymer is from about 250,000 to about 3,000,000 g/mol.

6. A composition according to claim 1 wherein the molar mass of the polymer is from about 275,000 to about 1,000,000 g/mol.

7. A composition according to claim 1 wherein the molar mass of the polymer is from about 300,000 to about 500,000 g/mol.

8. A composition according to claim 1 wherein the level of polymer is from about 0.05% to about 5% by weight of the composition.

9. A composition according to claim 1 wherein the surfactant system and the polymer are in a weight ratio of from about 10:1 to about 300:1.

10. A composition according to claim 1 wherein the surfactant system comprises an anionic surfactant and an amphoteric and or a zwitterionic surfactant wherein the anionic surfactant and the amphoteric and or the zwitterionic surfactant are in a weight ratio of less than about 9:1

11. A composition according to claim 10 wherein the anionic surfactant is an alkoxylated anionic surfactant

12. A composition according to claim 1 wherein the surfactant system comprises an amphoteric surfactant and wherein the amphoteric surfactant comprises at least about 60% by weight thereof of an amine oxide surfactant.

13. A composition according to claim 1 wherein the surfactant system comprises an amphoteric and a zwitterionic surfactant wherein the amphoteric and the zwitterionic surfactant are in a weight ratio of from about 2:1 to about 1:2.

14. A composition according to claim 1 wherein the surfactant system further comprises a non-ionic surfactant.

15. A method of manually washing dishware comprising the step of: delivering a composition according to claim 1 to a volume of water to form a wash liquor and immersing the dishware in the liquor.

16. A method of manually washing of dishware comprising the step of: delivering a composition according to claim 1 directly onto the dishware or onto a cleaning implement and using the cleaning implement to clean the dishware.
